(19) United States
(12) Patent Application Publication
(10) Pub. No.: US 2025/0342545 A1
(43) Pub. Date: Nov. 6, 2025

(54) SYSTEM AND METHOD FOR MODIFYING A COURSE

(71) Applicant: Guided Learning, LLC, Cape Coral, FL (US)

(72) Inventor: Joseph MERCOLA, Ormond Beach, FL (US)

(21) Appl. No.: 19/195,643

(22) Filed: Apr. 30, 2025

Related U.S. Application Data
(60) Provisional application No. 63/641,143, filed on May 1, 2024.

(51) Int. Cl. G06Q 50/20; G06N 3/092

(52) U.S. Cl. CPC G06Q 50/20; G06N 3/092

(57) ABSTRACT

Systems, methods, and non-transitory computer-readable storage media which provide a technical solution to the technical problem described. A method for performing the concepts disclosed herein may include: identifying, via at least one processor of a computer system, a course to be presented to a user, the course having at least a first portion and a second portion; presenting, via the computer system, the first portion to the user; receiving, at the computer system from the user, at least one user response based on the presenting of the first portion; evaluating, via the at least one processor of the computer system, the at least one user response, resulting in a user evaluation; modifying, via the at least one processor, the second portion, resulting in a modified second portion; and presenting, via the computer system, the modified second portion to the user.

### CROSS-REFERENCE TO RELATED APPLICATIONS

The present application claims priority to Provisional U.S. Patent Application Ser. No. 63/641,143, filed May 1, 2024, the disclosure of which is incorporated herein by reference in its entirety.

### BACKGROUND

The present disclosure relates to adaptive learning using artificial intelligence (AI), and more specifically to a learning platform that adapts content based on real-time comprehension evaluation.

Increasing amounts of education occur using software. While software education tools, whether online or localized, may provide amazing access to a wide variety of information, software education tools have traditionally lacked the ability to adapt to a student's comprehension of a subject. When software education tools do not adjust to, or match, a student's comprehension of a subject, the student learns less. Either the education is too advanced for the student to grasp and learn, or is too rudimentary and the student is learning less than they could in the same amount of time. Therefore, what is needed is a system that provides software education tools that continuously adjust to and match a student's comprehension of the material being taught.

### SUMMARY

Additional features and advantages of the disclosure will be set forth in the description that follows, and in part will be understood from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

Disclosed are systems, methods, and non-transitory computer-readable storage media which provide a technical solution to the technical problem described. A method for performing the concepts disclosed herein may include: identifying, via at least one processor of a computer system, a course to be presented to a student, the course having at least a first portion and a second portion; presenting, via the computer system, the first portion to the student; receiving, at the computer system from the student, at least one student response based on the presenting of the first portion; evaluating, via the at least one processor of the computer system, the at least one student response, resulting in a student evaluation; modifying, via the at least one processor, the second portion, resulting in a modified second portion; and presenting, via the computer system, the modified second portion to the student.

A system configured to perform the concepts disclosed herein may include: at least one processor; and a non-tangible computer-readable storage medium having instructions stored which, when executed by the at least one processor, cause the at least one processor to perform operations comprising: identifying a course to be presented to a student, the course having at least a first portion and a second portion; presenting the first portion to the student; receiving, from the student, at least one student response based on the presenting of the first portion; evaluating the at least one student response, resulting in a student evaluation; modifying the second portion, resulting in a modified second portion; and presenting the modified second portion to the student.

A non-transitory computer-readable storage medium configured as disclosed herein may have instructions stored which, when executed by at least one processor, cause the at least one processor to perform operations which include: identifying a course to be presented to a student, the course having at least a first portion and a second portion; presenting the first portion to the student; receiving, from the student, at least one student response based on the presenting of the first portion; evaluating the at least one student response, resulting in a student evaluation; modifying the second portion, resulting in a modified second portion; and presenting the modified second portion to the student.

### BRIEF DESCRIPTION OF FIGURES

FIG. 1 illustrates an example process for adapting content based on student performance;

FIG. 2 illustrates an example of interactions between a student and a Large Language Model (LLM);

FIG. 3 illustrates an example method embodiment; and

FIG. 4 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure. While this disclosure uses the term student, the disclosure encompasses any user of the disclosed embodiments, whether a student or not. Additionally, while this disclosure may refer to a course or courses, the disclosure encompasses any training, educational, or information presentation format.

Systems configured as disclosed herein address the limitations of traditional educational methods, which often fail to provide personalized, adaptive, and engaging learning experiences. Existing solutions lack the ability to assess student comprehension in real-time, adapt to individual learning needs, and scale the assessment process without manual intervention. This results in suboptimal learning outcomes and inefficient use of educational resources. Unlike conventional e-learning engines, the present system dynamically instantiates plural machine-learning micro-services that simultaneously (i) compute a comprehension score, (ii) push parameter deltas to an inference cache, and (iii) re-render client-side assets—thereby reducing end-to-end latency by at least 30% versus a non-adaptive baseline.

Such systems may utilize a combination of Large Language Models (LLMs) and Machine Learning (ML) systems to provide an adaptive education for students, where the needs of students who are struggling or excelling may be met. Such systems may include technical features such as the following.

Conversational Instruction: The system may use an LLM to engage students in natural language interaction, and may guide them through lessons and adapt the conversation based on their responses.

Real-time Comprehension Evaluation: The system may embed evaluation questions and prompts within the conversational flow, and may analyze student responses to gauge their level of understanding.

Adaptive Learning: The system may use additional LLM and ML systems to evaluate student performance and engagement, and based on that evaluation adapt the learning content, pace, and style of course content to optimize learning outcomes for each individual.

Scalable Assessment: The system may use ML algorithms that may automatically assess student responses, provide immediate feedback, generate performance reports, and enable scalable evaluation without manual grading.

The advantages of disclosed embodiments may include personalized learning experiences, real-time feedback, adaptive content delivery, and automated assessment, leading to improved learning outcomes and efficiency.

Technical improvements associated with disclosed embodiments may include: Adaptive content creation and real-time student assessment through LLMs and ML systems; Parallel processing of student interactions and assessments (i.e., as the content is being presented to the student, the system is simultaneously/in parallel evaluating the student's comprehension of the material being taught), enabling scalability; Increased accuracy in comprehension evaluation and personalized recommendations through the use of ML algorithms; Overall improved computational efficiency by adapting the learning content and pace based on individual student needs, such that the total computing time required for providing the course resources is the minimum amount required for the student to achieve a desired level of comprehension.

The system may generally have the following characteristics: conversational interaction between the student and the learning system, with the system guiding the lesson and adapting based on student responses; Real-time comprehension evaluation embedded within the conversational flow, with the system analyzing student responses to assess understanding; Adaptive learning experiences that dynamically adjust the content, pace, and style based on individual student performance and engagement; Automated assessment and feedback provided by the system, without the need for manual grading; Integration with existing educational platforms through APIs or plugins, enabling seamless data exchange and synchronization.

Consider the following example. Educational content may be input into the system, which may be processed and structured by the LLM. Students may initiate a conversation with the LLM, which may guide them through lesson content. The LLM may adapt the conversation based on student responses, asking questions and providing explanations to enhance understanding. Evaluation questions and prompts may be embedded within the conversation to assess student comprehension in real-time. Student responses may be analyzed by ML algorithms to determine their level of understanding and provide immediate feedback. The system may continuously collect and analyze student performance and engagement data, and based on the continuous analysis, the system may adapt the learning content, pace, and style to optimize the learning experience for each student.

The system may have flexible content integration, with the ability to input and utilize any educational content or principles as the source material. This may include support for various content formats, including text, images, videos, and interactive elements, along with seamless integration of content from multiple sources and disciplines.

The system may utilize an LLM (or multiple LLMs, depending on the configuration) to engage students in a conversational learning experience. The LLM may guide students through lessons using natural language interaction, with the LLM adapting the conversation based on student responses and understanding, and employing techniques such as asking clarifying questions, providing examples, and offering analogies to enhance comprehension. The LLM may be fine-tuned on a dataset of educational content and student interactions, where the model learns to generate appropriate responses based on the student's input and the lesson context. The training data may include examples of how to provide clarifying questions, examples, and analogies in response to various levels of student understanding. Additionally, the LLM may be combined with a separate classifier model that assesses student comprehension based on their responses, and this assessment may be used to guide the LLM in adapting the conversation.

The system may perform real-time comprehension evaluation, assessing student comprehension and retention while the lesson is being presented. In some embodiments, this evaluation may occur by embedding evaluation questions and prompts within the conversational flow, and analyzing student responses to gauge their level of understanding. The system may utilize various question types, such as multiple-choice, open-ended, and scenario-based questions, to assess different aspects of comprehension. The system may deploy additional mechanisms for determining the student's level of comprehension, including using pictures and/or video of the student to identify emotions being displayed by the student. For example, the student may be listening to the course content, and the system may capture an image or video of the student, perform an emotional detection analysis on the image or video, and determine based on that emotional detection that the student is not listening or otherwise engaged with the course. The system may also base its determination on other data, such as historical data from other users. Based on that determination, the system may adapt the content. The system may adapt the content to optimize a learning path of a student. Optimization may include any improvement to the outcomes the student experiences, such as a faster completion, higher score or grade, or other metrics. In some embodiments the comprehension evaluation may not be real time, or may occur between uses of the system.

The adaptive learning system may use additional LLM and ML systems to evaluate student responses and conversation (i.e., more than just a single LLM and a single ML system). LLMs/ML systems may analyze patterns and trends in student performance and engagement, which may then be used to adapt the learning content, pace, and style based on individual student needs. The system may also use reinforcement learning techniques to optimize the learning path for each student and incorporate gamification elements to enhance student motivation and engagement. For example, the system may update parameters of a model via a reinforcement-learning optimizer that maximizes a mastery reward; and serialize the parameters into a non-transitory medium for use with future students. The system may use a reinforcement learning algorithm, such as Q-learning or Deep Q-Networks (DQN), to learn an optimal policy for selecting the next content item or question based on the student's state (e.g., their performance on previous questions, time spent on the lesson, etc.). A reward function may be designed to promote actions that lead to higher student comprehension and engagement, such as providing more detailed explanations for struggling students or presenting more challenging questions to students who are excelling. The LLMs/ML systems may explore different actions and learn from the resulting rewards to continuously improve their content selection strategy. In some embodiments, the same steps may instead be performed by rule or logic based algorithms that do not use LLMs/ML systems.

In some embodiments, the adaptive learning system may utilize reinforcement learning techniques to optimize the learning path for each student. Reinforcement learning techniques include a type of machine learning where a system learns to make decisions by interacting with an environment and receiving rewards or penalties based on its actions. The system may use reinforcement learning to dynamically select the most effective content, questions, or examples for each student based on their real-time responses and performance, with effectiveness meaning maximizing their comprehension and engagement.

The personalized learning experience provided by disclosed embodiments may tailor the educational content and approach to each student's strengths, weaknesses, and learning preferences. The system may continuously refine the learning system based on student performance and feedback, optimize the learning outcomes for each individual student, and provide personalized recommendations for additional resources and activities to support learning. The system may also refine the learning system based on other user's data or based on refinement such as federated machine learning. Personalized recommendations may be provided to a user as a suggestion of course content to complete, or other forms of recommended content for their learning experience. In some embodiments, the system may not provide the recommendation to the user and may instead adapt the content automatically. In other embodiments, the recommendations may be provided to a third party, such as a parent, teacher, organization, or any other third party, that then may choose whether the student will follow the recommendation. For example, a teacher may be given the choice of whether to accept a recommendation for the next homework assignment the student will be given, without the student seeing the recommendation. In this example, the teacher may accept the recommendation or may select other work to assign as homework.

The system may collect data on student interactions, responses, and performance as they progress through the lessons. This data may be used to update the LLM and reinforcement learning models periodically, allowing them to adapt to new patterns and improve their decision-making. For example, the LLM may be fine-tuned on the latest student interaction data to generate more relevant and effective responses. The reinforcement learning model may update its Q-values based on the observed rewards and adjust its content selection policy accordingly. Additionally, the system may use A/B testing or multi-armed bandit algorithms to compare the effectiveness of different content variations and optimize the learning experience over time.

The system may provide scalable and automated student assessment, utilizing ML algorithms to automatically assess student responses and provide immediate feedback, generating performance reports and insights for educators and administrators, and enabling scalable evaluation of student progress without manual grading. In addition, the system may provide analytics and visualizations to track student performance and identify areas for improvement.

The system may integrate with existing educational platforms, using Application Programming Interfaces (APIs) and plugins for easy adoption and implementation, thereby ensuring compatibility with various devices and operating systems, and enabling single sign-on (SSO) and data synchronization with existing student records. Likewise, the system may deploy robust data protection measures to safeguard student information, complying with relevant privacy regulations and guidelines (e.g., Family Educational Rights and Privacy Act (FERPA), General Data Protection Regulation (GDPR)). This may include providing secure authentication and authorization mechanisms for system access, encrypting sensitive data both in transit and at rest, and conducting regular security audits and vulnerability assessments.

The system may be used as part of collaboration and social learning, by providing collaborative learning features, such as group discussions and peer feedback, and facilitating social learning experiences through virtual study groups and forums. The system The system may enable educators to monitor and moderate student interactions, while providing tools for students to share their learning progress and achievements with others.

In addition, the system may perform continuous improvement and updating, with the system collecting user feedback and incorporating it into future iterations of the learning system, and regularly updating the educational content to ensure relevance and accuracy. The system may prevent plagiarism and other workarounds by employing a randomization to each use of an LLM or ML system in order to generate different prompts.

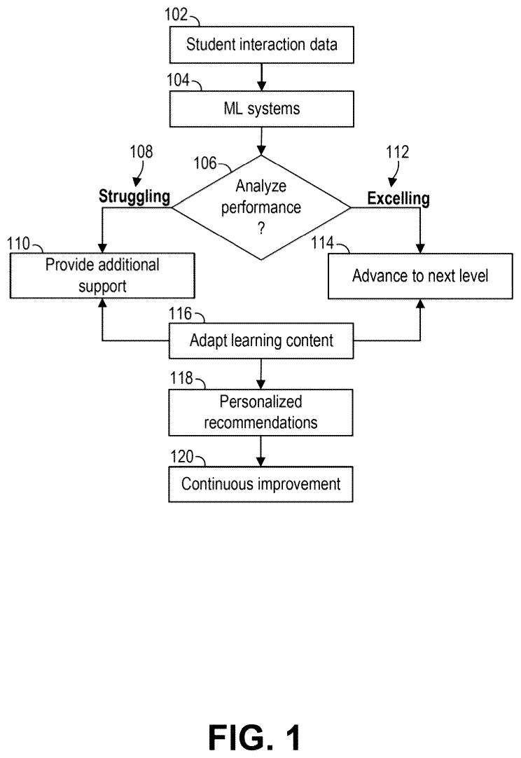

FIG. 1 illustrates an example process for adapting content based on student performance. As illustrated, the system may receive student interaction data 102, which may be provided to a Machine Learning (ML) system 104. The ML system 104 may analyze the performance 106 of a student based on the student interaction data 102, and may determine if the student is struggling 108 or excelling 112. For example, the ML system 104 may analyze the student interaction data received at 102 to determine if there are semantic mistakes or misconceptions in the user's answer. If the student is struggling 108, the system may provide additional support 110 in the form of personalized recommendations 118. Non-limiting examples of such personalized recommendations 118 may include one or more recommendations for backing up a step, repeating content, asking questions about what the student does not understand, providing explanatory feedback, etc. If the student is excelling 112, the system may advance the student to the next level 114, possibly in the form of personalized recommendations 118, and may allow the student to bypass content if the student shows a desired level of mastery. For both struggling 108 students and excelling 112 students, the personalized recommendations 118 may come through adapting learning content 116 from what was initially found in the course content to what is needed by the student. In the case of the struggling 108 student, the course content may need to be adapted to help the student learn the material. In the case of the excelling 112 student, the course content may need to be adapted to help the student remain engaged with the content (rather than being bored by reviewing information which the student has already learned). In this manner, the system may provide continuous improvement 120 to the student. In alternative embodiments, the system may provide continuous improvement 120 without providing personalized recommendations 118 to the user if other steps besides personalized recommendations 118 will improve the student's performance.

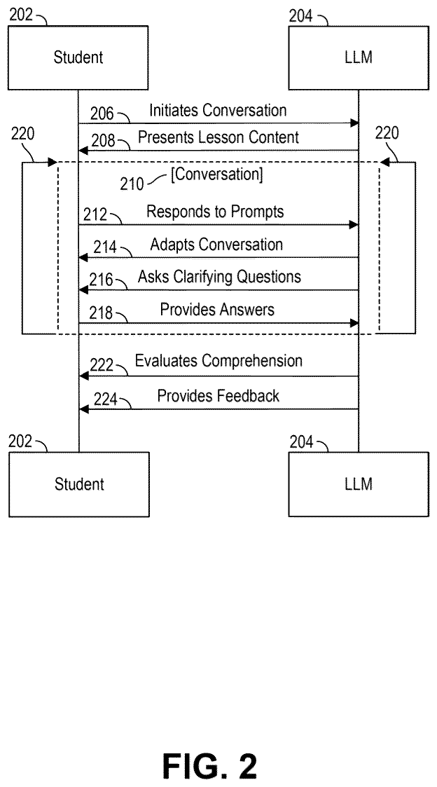

FIG. 2 illustrates an example of interactions between a student 202 and a Large Language Model (LLM) 204. In this example, the student 202 may interact with the system, which may contain (or utilize) a LLM 204, and as the student 202 provides answers the system may adapt the conversation based on the student's responses. As illustrated, the student may initiate the conversation 206 (e.g., “I want to learn about astronauts”) and the system may present lesson content 208 (e.g., a video about astronauts, containing questions for the student). As the student engages with the system (i.e., through typing, speech, video, and/or other modes of communication), a conversation 210 may occur between the student 202 and the LLM 204.

The conversation 210 may include the student 202 responding to prompts 212, the student's responses 212 being received by the LLM 204, and the LLM 204, in turn, adapting the conversation 214 (i.e., adapting subsequent content which had been queued up or is otherwise part of the initial content). If, for example, the system was initially configured to present to the student 202 the first video and a second video, but then detects the student struggling to understand what outer space is, the system may adapt the course content to instead discuss the nature of Earth, planets, and/or other celestial bodies. The system may also ask clarifying questions 216 to the student 202, to which the student may provide answers 218, allowing the system to determine the level of understanding/proficiency the student 202 has in the subject. This process may loop 220 as needed, until the course is completed. At that point the system, via the LLM 204, may evaluate the overall course comprehension 222 of the student 202 and provide feedback 224 to the student 202.

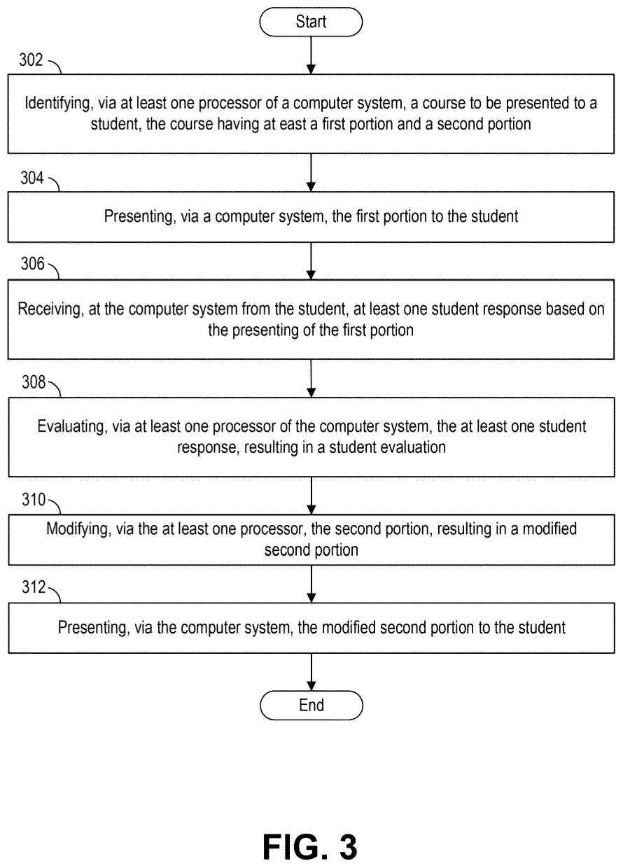

FIG. 3 illustrates an example method embodiment. As illustrated, an exemplary method for performing the concepts disclosed herein may include: identifying, via at least one processor of a computer system, a course to be presented to a student, the course having at least a first portion and a second portion (302), and presenting, via the computer system, the first portion to the student (304). The method may continue by receiving, at the computer system from the student, at least one student response based on the presenting of the first portion (306) and evaluating, via the at least one processor of the computer system, the at least one student response, resulting in a student evaluation (308). The method may then modify, via the at least one processor, the second portion, resulting in a modified second portion (310), and presents, via the computer system, the modified second portion to the student (312).

In some embodiments, the evaluating of the at least one student response via the at least one processor may occur by executing at least one machine learning model using the at least one student response as an input. Non-limiting examples of machine learning models may include Artificial Intelligence (AI) algorithms, neural networks, and/or computational models. The at least one machine learning model may include a neural network, the neural network having been trained on a plurality of training pairs, each pair in the plurality of training pairs comprising: a previous student response; and a previous student comprehension determined after the previous student response.

The at least one student response may include at least one of: an answer to a question regarding the first portion; an amount of time between presentation of the question and when the student provided the answer; and video capturing at least one facial expression of the student while answering the question.

In some embodiments, the at least one machine learning model may utilize a Large Language Model (LLM); and the LLM may perform the modifying of the second portion using a prompt, the prompt based on the student evaluation.

In some embodiments, the modifying of the second portion may include inserting an example into the second portion, where the example was not previously included in the second portion.

In some embodiments, the modifying of the second portion may comprise inserting an additional question into the second portion, where the additional question was not previously included in the second portion.

In some embodiments, the presenting of the first portion and the presenting of the modified second portion may be performed using at least one of: a display of the computer system; and a speaker of the computer system.

In some embodiments, the at least one student response may include data indicative of student comprehension of the first portion.

In some embodiments, the at least one machine learning model may utilize Natural Language Processing (NLP), wherein the NLP performs the modifying of the second portion using a prompt, the prompt based on the student evaluation. The NLP may include use of Large Language Models (LLMs) and other types of NLP models.

In some embodiments, the modifying of the second portion may include dynamically adjusting the content of the second portion based on the student evaluation.

In some embodiments, the at least one machine learning model may include a reinforcement learning model that selects content for the modified second portion based on a reward function that optimizes student comprehension.

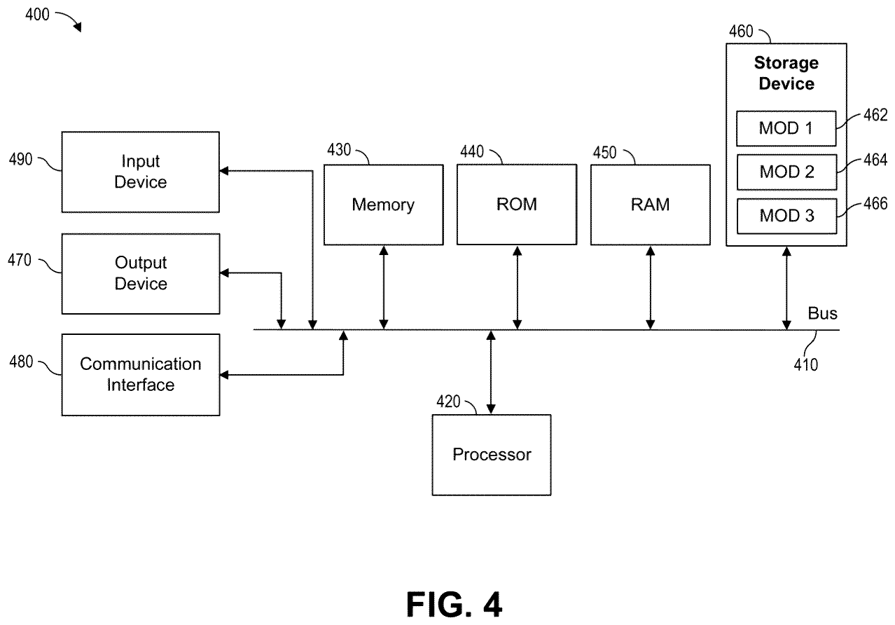

With reference to FIG. 4, an exemplary system includes a computing device 400 (such as a general-purpose computing device), including a processing unit (CPU or processor) 420 and a system bus 410 that couples various system components including the system memory 430 such as read-only memory (ROM) 440 and random access memory (RAM) 450 to the processor 420. The computing device 400 may include a cache of high-speed memory connected directly with, in close proximity to, or integrated as part of the processor 420. The computing device 400 may copy data from the system memory 430 and/or the storage device 460 to the cache for quick access by the processor 420. In this way, the cache may provide a performance boost that avoids processor 420 delays while waiting for data. These and other modules may control or be configured to control the processor 420 to perform various actions. Other system memory 430 may be available for use as well. The system memory 430 may include multiple different types of memory with different performance characteristics. It can be appreciated that the disclosure may operate on a computing device 400 with more than one processor 420 or on a group or cluster of computing devices networked together to provide greater processing capability. The processor 420 may include any general-purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in memory ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 may include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, system bus 410, output device 470 (such as a display or speaker), and so forth, to carry out the function. In another aspect, the system may use a processor and computer-readable storage medium to store instructions which, when executed by a processor (e.g., one or more processors), cause the processor to perform a method or other specific actions. The basic components and appropriate variations are contemplated depending on the type of device, such as whether the computing device 400 is a small, handheld computing device, a desktop computer, or a computer server.

Although the exemplary embodiment described herein employs the storage device 460 (such as a hard disk), other types of computer-readable media which may store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. Inputs may include multi-modal inputs as well as physiological sensors to detect inputs such as eye tracking, facial expressions, body posture, galvanic skin responses, speech input, heart rate, or other physiological signals. An output device 470 may also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed. The system may be contained on both edge nodes of a network or on cloud computing hardware, or a combination of both. The system may dynamically adjust what hardware is used based on a variety of factors including the difference in latency between the cloud computing and the edge node computing.

The technology discussed herein refers to computer-based systems and actions taken by, and information sent to and from, computer-based systems. One of ordinary skill in the art will recognize that the inherent flexibility of computer-based systems allows for a great variety of possible embodiments, combinations, and divisions of tasks and functionality between and among components. For instance, processes discussed herein may be implemented using a single computing device or multiple computing devices working in combination. Databases, memory, instructions, and applications may be implemented on a single system or distributed across multiple systems. Distributed components may operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

We claim:

1. A method comprising:
identifying, via at least one processor of a computer system, a course to be presented to a user, the course having at least a first portion and a second portion;
presenting, via the computer system, the first portion to the user;
receiving, at the computer system from the user, at least one user response based on the presenting of the first portion;
evaluating, via the at least one processor of the computer system, the at least one user response, resulting in a user evaluation;
modifying, via the at least one processor, the second portion, resulting in a modified second portion; and
presenting, via the computer system, the modified second portion to the user.

2. The method of claim 1, wherein the evaluating of the at least one user response via the at least one processor occurs by executing at least one machine learning model using the at least one user response as an input.

3. The method of claim 2, wherein the at least one machine learning model comprises a neural network, the neural network having been trained on a plurality of training pairs, each pair in the plurality of training pairs comprising:
a previous user response; and
a previous user comprehension determined after the previous user response.

4. The method of claim 2, wherein the at least one user response comprises data indicative of user comprehension of the first portion.

5. The method of claim 2, wherein:
the at least one machine learning model utilizes Natural Language Processing (NLP); and
wherein the NLP performs the modifying of the second portion using a prompt, the prompt based on the user evaluation.

6. The method of claim 2, wherein the at least one machine learning model comprises a reinforcement learning model that selects content for the modified second portion based on a reward function that optimizes user comprehension.

7. The method of claim 1, wherein the modifying of the second portion comprises inserting an example into the second portion, where the example was not previously included in the second portion.

8. The method of claim 1, wherein the modifying of the second portion comprises inserting an additional question into the second portion, where the additional question was not previously included in the second portion.

9. The method of claim 1, wherein the modifying of the second portion comprises dynamically adjusting the content of the second portion based on the user evaluation.

10. The method of claim 1, wherein the presenting of the first portion and the presenting of the modified second portion are performed using at least one of:
a display of the computer system; and
a speaker of the computer system.

11. A system comprising:
at least one processor;
a non-tangible computer-readable storage medium having instructions stored which, when executed by the at least one processor, cause the at least one processor to perform operations comprising:
identifying, via at least one processor of a computer system, a course to be presented to a user, the course having at least a first portion and a second portion;
presenting, via the computer system, the first portion to the user;
receiving, at the computer system from the user, at least one user response based on the presenting of the first portion;
evaluating, via the at least one processor of the computer system, the at least one user response, resulting in a user evaluation;
modifying, via the at least one processor, the second portion, resulting in a modified second portion; and
presenting, via the computer system, the modified second portion to the user.

12. The system of claim 11, wherein the evaluating of the at least one user response via the at least one processor occurs by executing at least one machine learning model using the at least one user response as an input.

13. The system of claim 12, wherein the at least one machine learning model comprises a neural network, the neural network having been trained on a plurality of training pairs, each pair in the plurality of training pairs comprising:
a previous user response; and
a previous user comprehension determined after the previous user response.

14. The system of claim 12, wherein the at least one user response comprises data indicative of user comprehension of the first portion.

15. The system of claim 12, wherein:
the at least one machine learning model utilizes Natural Language Processing (NLP); and
wherein the NLP performs the modifying of the second portion using a prompt, the prompt based on the user evaluation.

16. The system of claim 12, wherein the at least one machine learning model comprises a reinforcement learning model that selects content for the modified second portion based on a reward function that optimizes user comprehension.

17. The system of claim 11, wherein the modifying of the second portion comprises inserting an example into the second portion, where the example was not previously included in the second portion.

18. The system of claim 11, wherein the modifying of the second portion comprises inserting an additional question into the second portion, where the additional question was not previously included in the second portion.

19. The system of claim 11, wherein the modifying of the second portion comprises dynamically adjusting the content of the second portion based on the user evaluation.

20. A non-tangible computer-readable storage medium having instructions stored which, when executed by a processor, cause the processor to perform operations comprising:
identifying, via at least one processor of a computer system, a course to be presented to a user, the course having at least a first portion and a second portion;
presenting, via the computer system, the first portion to the user;
receiving, at the computer system from the user, at least one user response based on the presenting of the first portion;
evaluating, via the at least one processor of the computer system, the at least one user response, resulting in a user evaluation;
modifying, via the at least one processor, the second portion, resulting in a modified second portion; and
presenting, via the computer system, the modified second portion to the user.
